(19) United States
(12) Patent Application Publication
(10) Pub. No.: US 2009/0164248 A1
(43) Pub. Date: Jun. 25, 2009

(54) System and Method for Patient Management/Communication with Intervention

(75) Inventors: Jacquelyn Suzanne Hunt, North Plains, OR (US); Joseph Siemienczuk, Clackamas, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: PROVIDENCE MEDICAL GROUP, A DIVISION OF PROVIDENCE HEALTH SYSTEM, Portland, OR (US)

(21) Appl. No.: 11/963,259

(22) Filed: Dec. 21, 2007

(51) Int. Cl. G06Q 50/00; G06F 17/00

(52) U.S. Cl. 705/3; 705/2

(57) ABSTRACT

A patient management system, comprising of a care provider interface, configured to receive a selection of a plurality of patients and a data processing system configured to signal whether to exclude an individual patient within a subset of the plurality of patients based on an intervention parameter and further configured to send a communication to each of the patients in the subset.

### BACKGROUND

Communication between a care provider and a patient is important for high-quality medical care. In addition to communications during treatment, communications between a patient and care provider, such as a physician, nurse, or care provider facility, occur prior to and after treatment.

Communication between a care provider, such as a health care provider, and a patient may be limited due to various constraints, including time, number of patients, etc. For example, a single care provider may manage thousands of patients, and may have limited opportunities to present and review complex medical information or initiate proactive client interaction. Database management systems have been developed to store individual patient records, but although these management systems provide access to individual patient records, the systems provide little or no support for customized pre-treatment and post-treatment communication with the patient. For example, care providers may need to communicate with patients regarding pre-treatment and/or post-treatment tests, appointments, medical interventions, etc. However, due to the large number of patients and complex issues surrounding the medical profession, such communications may be costly and time-consuming.

### SUMMARY

A system and a method are provided for improving patient care and communication, in particular a system and method are provided for generating personalized patient-specific communications to a plurality of patients.

In one example, a patient management system, comprising: a care provider interface, configured to receive a selection of a plurality of patients; and a data processing system configured to signal whether to exclude an individual patient within a subset of the plurality of patients based on an intervention parameter and further configured to send a communication to each of the patients in the subset.

By providing a system and method for patient communication as described above, it may be possible to allow healthcare providers to send patients personalized and patient-specific communications to multiple patients with reduced effort and time, while avoiding sending communications to patients that, while technically meeting certain criteria, have other reasons why such a communication may be unnecessary. In this way, more personalized communication may be achieved without overburdening the care provide.

### BRIEF DESCRIPTION OF THE FIGURES

FIG. 1 illustrates an example patient management/communication system.

FIG. 2A illustrates an example patient management/communication work flow process.

FIG. 2B further continues the work flow process of FIG. 2A.

FIG. 3 illustrates an example main menu interface of a patient management/communication system.

FIG. 4 illustrates an example treatment tab of a patient management/communication system.

FIG. 5 illustrates an example patient communication window.

FIG. 6 illustrates an example custom patient communication message template.

FIG. 7 illustrates another example patient communication message template.

FIG. 8 illustrates an example audit trail feature and audit trail communication log linked to the audit trail feature of a patient management/communication system.

FIG. 9 illustrates an example intervention tracking detail window.

FIG. 10 illustrates a main menu of an example intervention dashboard for a disease management module.

FIG. 11 illustrates an intervention tracking interface of an example intervention dashboard.

FIG. 12 illustrates an example filter builder interface for a patient management/communication system.

FIG. 13 illustrates an example interface for accessing a predefined filter for a patient management/communication system.

FIG. 14 illustrates an example interface applying a filter to the patient data in an exemplary system.

FIG. 15 illustrates another example filter builder in accordance with an embodiment of the present disclosure.

### DETAILED DESCRIPTION

A patient management/communication system for improving patient care and communication is described in more detail below. The system may assist providers in monitoring patients and pertinent aspects of their care, may alert patients and care providers of care opportunities, may improve communication with patients, and/or may enable or provide patient care information in a cost and time-effective manner improving health care services. For example, in some embodiments, the patient management/communication system may enable a care provider to easily generate customized patient communications. Further, in some embodiments, the system may enable the care provider to diagnose, identify potential issues, and/or monitor a patient's progress or long term care.

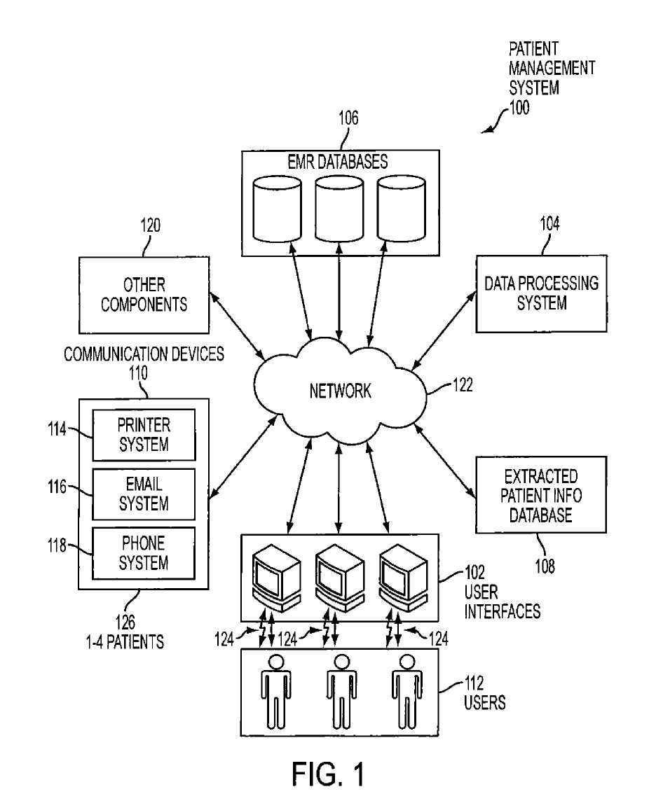

FIG. 1 illustrates an example patient management/communication system 100. The system 100 may include a plurality of user interfaces 102, a data processing system 104, a plurality of electronic medical record (EMR) databases 106, an extracted patient information database 108, various communication devices 110, and other components 120 that may be operatively coupled to a network 122. The various components of the patient management system 100 may communicate with each other by sending communication signals over network 122.

It should be appreciated that, in FIG. 1, the various elements or components of the patient management system 100 or any subsystems of the patient management system 100 are represented on a functional basis. Thus, for example, the user interfaces 102, the data processing system 104, the EMR databases 106, and/or the extracted patient information databases 108 may be implemented by a number of different hardware structures, by a single hardware structure, or by two or more hardware structures that combine different functional features provided by the user interfaces 102, the data processing system 104, and/or the extracted patient information database 108. Further, the various elements or components may also communicate data, information, commands, etc., with one another directly, over the network, or combinations thereof. The various elements may also represent software and/or code stored on computer readable media.

In some embodiments, the patient management/communication system (also referred to as a patient management system) 100 may enable a communication system where users (also referred to as providers) 112 can communicate with one or more patients 126. Patients 126 may be individuals who are under the care of the users or individuals who are being monitored by a user. As described in more detail below, users 112 may be linked through network 122 to one or more communication devices which enable access to patients 126. For example, the users may communicate with patients via communication devices or systems 110. As examples, and not as a limitation, communication systems may include a printer system 114 for generating personal letters, an electronic communication system, such as a message system, and/or a phone system 118. As described above, each of these communication systems may enable sending, storing and receipt of messages to patients. For example, the message system may include a web-based system, an email alert system which may direct a user through a web link to a website, and/or a direct email or message system. As such an email system 116 may be used to send and receive electronic messages between the provider system and the patient system. Such an email system may be an Internet based email systems or other network-based electronic communication system.

Users 112 may access the patient management system 100 via the plurality of user interfaces 102, either directly or indirectly via remote networking arrangements, as denoted by the straight and broken arrows 124. The user interfaces 102 may include one or more input and/or output devices, such as keyboards, mouses, touch screens, cell phones, personal data assistants, and/or voice recognition devices, display screens, speakers, etc. In a remote networking arrangement, the users 112 may access the user interfaces 102 via web-browsers (not shown), for example. The users, also referred to as care providers, 112 may include various persons and/or organization with sufficient authorization, such as physicians, clinicians, support staff, hospitals, and clinics. Each of the users 112 may have a different user privilege assigned. The user privileges may limit access based on the physician name, physician location, physician practice, etc.

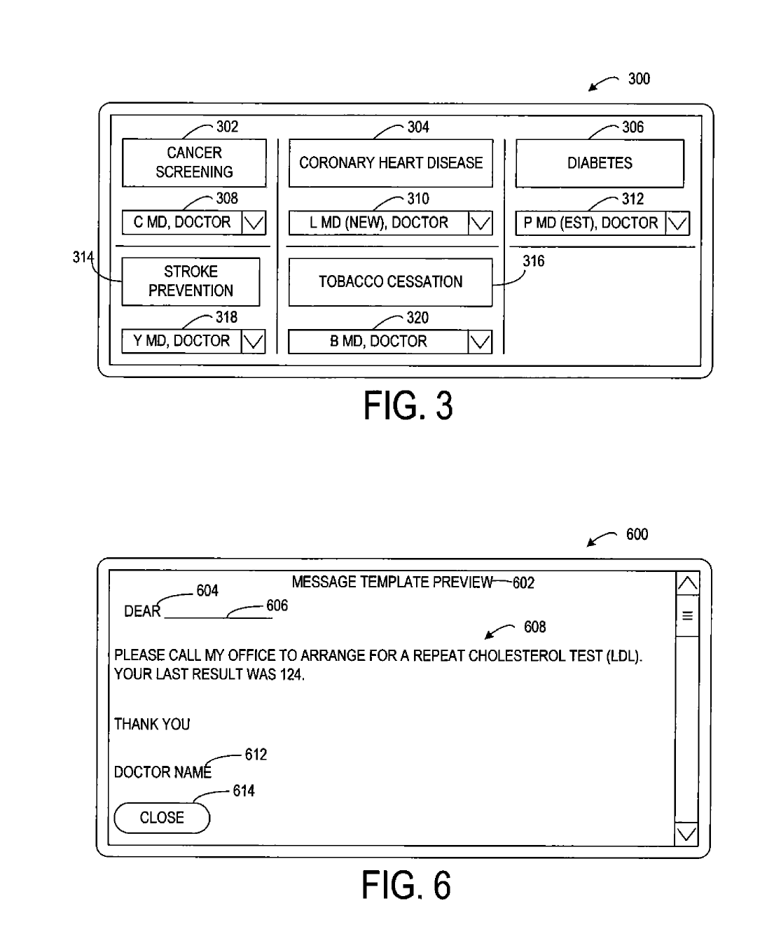

In one example, user interfaces 102 may include various graphical user interfaces (such as illustrated in FIGS. 3-11) that enable the users 112 to interact with the patient management system 100. The graphical user interfaces may include various menus, tabs, screens, and/or dashboards that enable the user 112 to interact with the patient management system 100. Further, a plurality of disease or health-related condition management modules (disease management modules) may be included for managing patients with a condition, such as a particular disease or health-related condition. For example, the modules may include a cancer screening module, stroke prevention module, coronary heart disease management module, tobacco cessation module, and/or diabetes module. Other modules may also be included, such as a pregnancy management module, osteoporosis management module, heart failure management module, case management module, mental health management module, etc.

In some embodiments, patient management system 100 may be configured to display patient information, including patient care parameters, in a summary table view of patients with a common condition (e.g. disease) or risk for a common condition, along with information relevant to the common condition. Such operation can facilitate identification of patients in need of care attention, without requiring review of complex medical charts of all patients. This summary table view of patient information may further facilitate identification of patients in need of additional checkups or tests, as well as the identification and selection of patients for patient communications. As an example, patient care parameters may include a patient's test results, a patient's medication, care provider data, patient health data, care provider instructions, appointment status, comorbidity diagnosis, etc.

Users 112 may generate communications to patients based on, and including, various patient information stored in an EMR database. EMR databases 106 may include one or more repositories or databases housing EMRs. An EMR may also be referred as an electronic health record (EHR), medical record, personal health record (PHR), patient generated information, and/or continuity of care record (CCR). For example, the EMR may include EMR data including patient care data, personal health care data, patient-generated data, etc. The EMR may include patient health records, documents, reports, charts, information and/or notes in digital format. An EMR or an EMR record may be accessed electronically, for example on a computer or over a network. It may include health information from many locations, sources, clinicians, healthcare providers, hospitals, and/or clinics. It may include information relating to the current and historical diseases, health conditions, and/or medical conditions, laboratory test results, etc. In addition, it may include data about medical referrals, medical treatments, medications and their applications, demographic information, information regarding last provider visits and upcoming visits and other non-clinical administrative information, such as patient financial records, institution financial records, payment and invoicing records and arrangements, Medicaid or Medicare rules and records, and so forth. Such data may be understood to be patient care or patient health parameters.

In general, creating and updating the EMR of a patient may be performed as part of routine patient care documentation during patient care. Further, care providers, such as doctors, may use the EMR in their day-to-day operation as the “patient chart.” Moreover, care providers may use the patient management system during the course of a visit or use the system for monitoring and managing patient care outside of an individual's visit.

The various EMR databases may be located at any number of physical locations. In some examples, there may be no direct communication or exchange of information or data between or among the various repositories of the EMR databases 106. In other examples, the various repositories of the EMR databases 106 may communicate between and among themselves. Software programs may be provided to coordinate, control, direct the flow or exchange of data or information between and among the various repositories of the EMR databases 106, and with other components of the patient management system 100, such as with the data processing system 104, the extracted patient information database 108, and the user interfaces 102.

The EMR databases 106 may be configured to receive patient data elements from various sources, for example via inputs from healthcare providers, supporting staffs of the healthcare provider, and/or from staffs of insurance companies. The EMR databases 106 may also be configured to receive patient care parameters via interfaces with various information systems, such as various medical test results. In some examples, the EMR databases 106 may be configured to receive patient information from a patient management system (e.g., 100). The data received by the EMR databases may be from various entities and/or locations, such as various hospitals, clinics, and/or other like sources. The patient data elements may be stored in the EMR databases as structured data that can be searched and extracted. Structured data may have an enforced composition to the data types that allows the data to be machine readable, and may be referred to as machine readable data.

In some embodiments, EMR databases 106 may be configured to be accessed by the data processing system 104 and/or by or through user interfaces 102. For example, the data processing system 104 may search the various repositories of the EMR databases 106, and upload the searched patient information elements or transfer the searched patient information elements to other databases, such as the extracted patient information database 108. As an example, the patient information elements may be combined to provide system reports such as patient status reports, patient care reports, etc. In some embodiments, users 112 also may directly search, modify, extract, and upload patient information elements from the EMR databases 106 or other databases.

The data processing system 104 may be configured to draw upon and implement programs of the patient management system 100 for coordinating, controlling, and directing the flow and/or extraction of data or information within and among the various components of the data processing system 104 and patient management system 100, such as EMR databases 106.

In one example, the data processing system 104 may be configured to search the EMR databases 106 to identify patient information elements based on predefined search criteria, and extract patient information elements from the EMR databases 106. In one specific example, the data processing system 104 may be configured to search and extract patient information elements from the EMR databases 106 for patients of a patient population. The patient population, for example, may include patients for a hospital, patients for a healthcare provider network, patients from a geographic location, or all the patients within the EMR databases 106.

In another example, the data processing system 104 may extract patient information elements from the EMR database 106 that have been entered into the following specific EMR structured data fields: (1) clinical lists, which may include problems, medications, allergies, and directories, and (2) observation terms entered into an EMR form or entered directly into a flow sheet. Information entered into the EMR as “free text”, for example typed into a blank page or a text component are not structured data and may not be extracted by the data processing system 104. It may also be possible for the patient management system 100 to extract and view non-structured data stored in the EMR databases 106, and/or to convert non-structured data stored in the EMR databases 106 into structured data, via the data processing system 104.

The data search and extraction schedule of the data processing system 104 may vary. The data extraction may be preprogrammed to occur periodically, such as minutely, hourly, daily, weekly, and/or monthly, or a combination of the above, etc. The data extraction may occur as a predefined condition is satisfied, for example a new test result of a patient is available. Or the data extraction may occur at a separate command, for example by the users 112 or a system manager. In one specific example, the data processing system 104 is programmed to extract data from the EMR databases 106 nightly, so any change made to EMR records in the EMR databases 106 today will be reflected in the patient management system 100 tomorrow, after the data processing system 104 has extracted the patient information from the EMR databases 106 is refreshed.

Data, such as EMR data, may be extracted from, and/or linked to, the EMR databases 106 stored in an extracted patient information database 108. In some embodiments, the extracted data may be re-formatted and/or restructured according to pre-determined rules specific to a particular disease management module. Further, as described below, various aspects of the patient management system may perform various operations based on patient data, such as patient data stored in the extracted patient information database 108. By extracting patient information elements from existing EMR databases, it may be possible to monitor and care for patients, in particular a population of patients, more efficiently.

The various components of the communication systems 110, which may include the printer system 114, the email system 116, and the phone system, may be operatively coupled within the system 100. The printer system 114 may include one or more printers located at any number of physical locations, where a staff member may be tasked with mailing printed letters. The email system 116 may include one or sending units (not shown) having a software modules (not shown), for example in the form of servers, to compose, and/or send emails to a plurality of patients according to a request, for example a request of the data processing system 104. The email system 116 may be configured to send and/or receive secured emails, for example via encryption. The phone system 118 may include one or more sending units (not shown) having software modules (not shown), for example in the form of servers that can generate voice messages according to the request, for example a request from the data processing system 116.

The network 122 may comprise a global network, such as the Internet, one or more other wide area network (WAN), a local area network (LAN), wireless communication networks, a wireless local area network (WLAN), satellite networks, etc. In the illustrated embodiment, the network further includes an institutional network, which may be maintained by institutions, such as hospitals, clinics, etc.

As described above, patient management system 100 may support various interface features which enable ease-of-use. These features, such as color-coding, symbols, information layout, etc. may be integrated into the customized communications send to a patient. For example, in some embodiments, patient management system 100 may utilize color coding in the display and organization of various patient information, such as based on a status of various patient information elements. For example, a patient care parameter, such as test results or a particular indicator level, may be coded in green if the parameter is in compliance with recommended care, or not overdue, or is below an evidence-based, guideline-recommended target. A patient care parameter may be coded in yellow, indicating that a test might be coming due shortly or that a test result is slightly or moderately above a target. A patient care parameter colored in red may indicate a concern such that a parameter might be overdue or a result might be significantly above a target. A patient care parameter colored in white may indicate that the guideline or evidence does not apply, or there is insufficient information available.

Such coding may facilitate medical decision making by providing healthcare providers at-a-glance views of patients who may be in need of care and at-a-glance views of the types of care needed, all without requiring the healthcare provider perform a detailed review the medical charts of all patients. As one example, a healthcare provider may quickly be able to identify all the patients with significantly elevated blood pressure (BP) by identifying the patients that have their BP entries colored red. Then, once the system has received a selection of the particular patients, the system can automatically generate personalized patient-specific communications to the selected patients, where the communication may be personalized based on particular health parameters of the patient. Continuing the BP example, the communication may alert each patient that an appointment, test, and/or consultation, is suggested, based on their elevated BP, with the communication referencing the patient's particular BP level. Thus, each patient receives a personalized communication with their particular BP level.

Further, the color coding may also be applied to various patient communication elements to makes it easier for a patient receiving a patient communication to better understand what he/she needs to do. For example, a first patient may know that he/she may needs to try to further lower her BP since her BP is colored red, while a second patient may learn that their course of action is making progress if their BP level is coded yellow.

However, even though a particular patient may have a BP level outside a desired range, the provider may nevertheless with to exclude the patient from receiving communications regarding BP due to other reasons. For example, the patient may have just taken a test and the results are not yet back, other more serious medical issues are present, or the previous test may have been compromised due to other medical issues, medication, etc. As such, the patient management system 100 may also be configured to track whether there are particular conditions in which care or communication regarding particular parameters is of high or low priority.

Further, the system may be configured to track when certain types of communications should or should not be sent to a patient. Such tracking may be referred to herein as an intervention tracking, and may represent an example of an intervention or exclusion parameter identifying when provider interaction or intervention has already occurred or overrides the more general communication. Thus, system 100 may link patient care parameters to a provider's intervention, so that even if the patient is selected for a communication, if the patient had been previously identified that such communications should not be sent, sending of the patient communication can be avoided. While the above illustrates one example exception, various others may be provided.

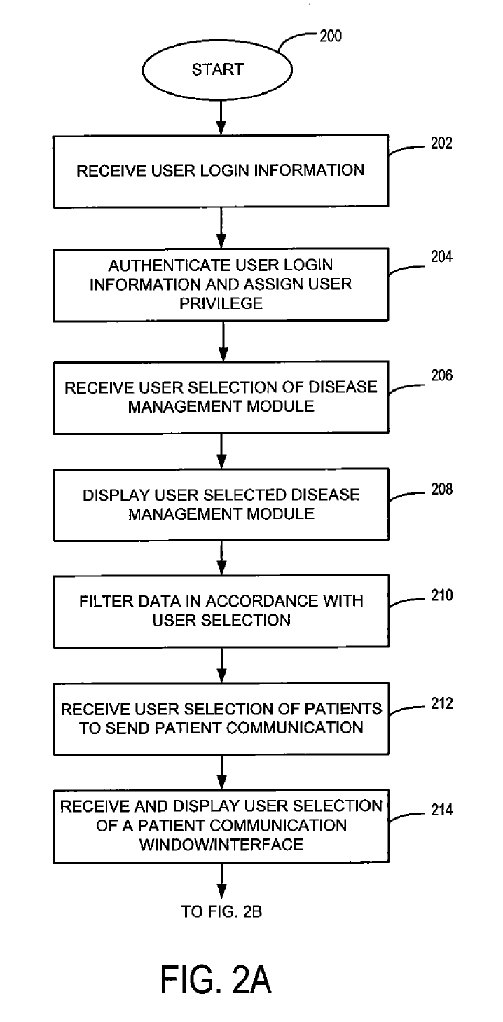

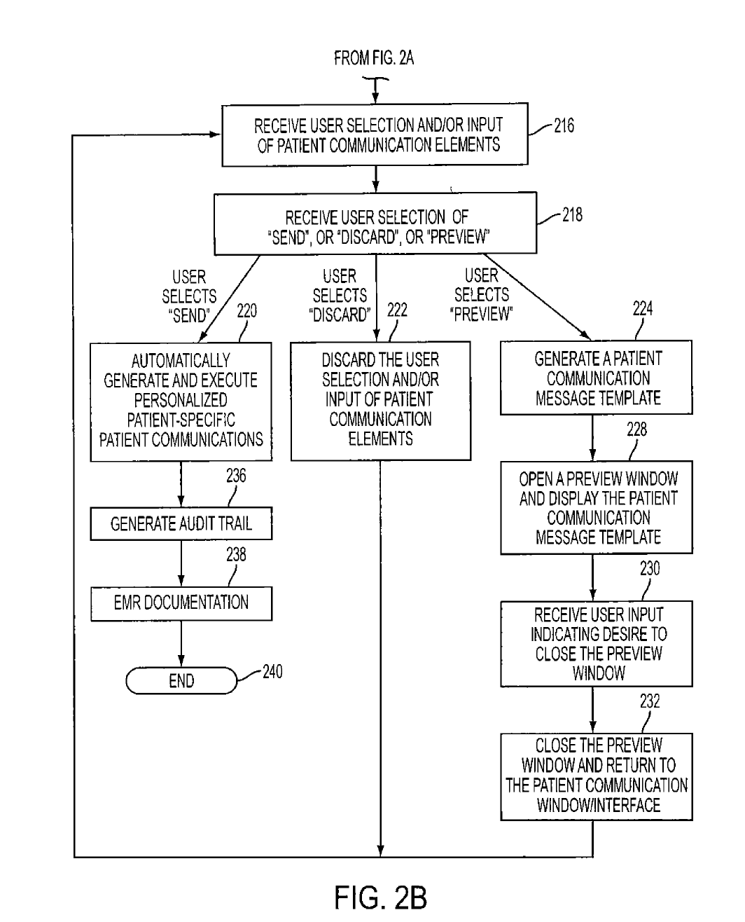

FIGS. 2A and 2B illustrate an example patient communication work flow process that may be implemented by the patient management/communication system 100 described in FIG. 1. In the example of FIGS. 2A and 2B, the routine illustrates facilitation of patient communication and management of patient data. For example, the routine may facilitate selection of patients for customized communications. Further, the routine illustrates how in some embodiments selected patients may be excluded from receiving communications based on an intervention parameter, such as intervention tracking within the system. It should be appreciated that FIGS. 3-11 illustrate example communications and interfaces for use with the process described in FIGS. 2A and 2B.

Before carrying out the routine of FIGS. 2A and 2B, the system may be initialized and updated. For example, the system may first extract relevant data from an EMR database, and associate various patients with particular conditions. As described below, the extracted and associated patient data may then be used and viewed in order to facilitate patient communication. The extracted information may include medical information, test results, diagnoses, personal information, as well as patient preferences, such as a preferred form of communication (e.g., e-mail, letter, fax, phone, etc.)

The routine starts at 200. At 202, the routine may receive user login information of the user 112 via, for example, a user login interface. The user login interface may include any suitable user login interfaces. For example, it may include graphical user interfaces that are configured to receive textual user identifications and passwords from a user. The user login interface may include biometric devices that recognize biometric characteristics of users. Such biometric devices may include, for example, voice recognition devices, finger print readers, facial characteristics readers, etc. The user login interface may include devices that detect characteristics of a piece of property possessed by a user, such as devices for recognizing keys and magnetic cards of a user.

At 204, the routine may authenticate the user login information to ascertain that the user 112 has authorization to access the patient management/communication system. The authentication may for example be carried out by comparing the user login information stored in a user login information database of a patient management system. The user login information database may for example reside in memory system of the data processing system 104.

The routine may also assign user privileges to the user 112 by looking up a user privilege database. The user privilege database may for example reside in the memory system of the data processing system 104. Depending on the user privileges assigned, the user 112 may have different ability, for example, to view certain information or to perform certain tasks. The user 112 may be assigned a privilege to view patient information for patients belonging to a particular physician, hospital, or clinic. In one example, the user 112 may only initiate patient communication for patients belonging to a particular physician, hospital, and/or clinic. As another example, depending on a user's privilege, the user may not be able to generate patient communications.

At 206, the routine may receive the user selection of a disease management module or other module to be displayed by the user interface 102. The user 112 may select the module, e.g. a disease management module, to be displayed from various disease management modules user inputs, such as selector-buttons 302-320 of the main menu 300 of the patient management/communication system 100 shown in FIG. 3. It should be appreciated that the user inputs may be any suitable selection input and such description relating to buttons is for illustrative purposes only.

As noted above, various disease management modules may be used. The disease management module may have rules or criteria that determines which extracted information is associated with the particular module. For example, the presence of diabetes in a patient's record may be used to identify or to associate a patient with the diabetes management module. In one particular example, a patient's problem may be used to associate a patient with a particular module, where the list may be a patient care parameter in a patient's EMR record for identifying diseases or health-related conditions associated to the patient. As another example, a patient's status (such as whether the patient is an active or inactive patient) in the EMR record and physician may be used to associate the patient with a particular module.

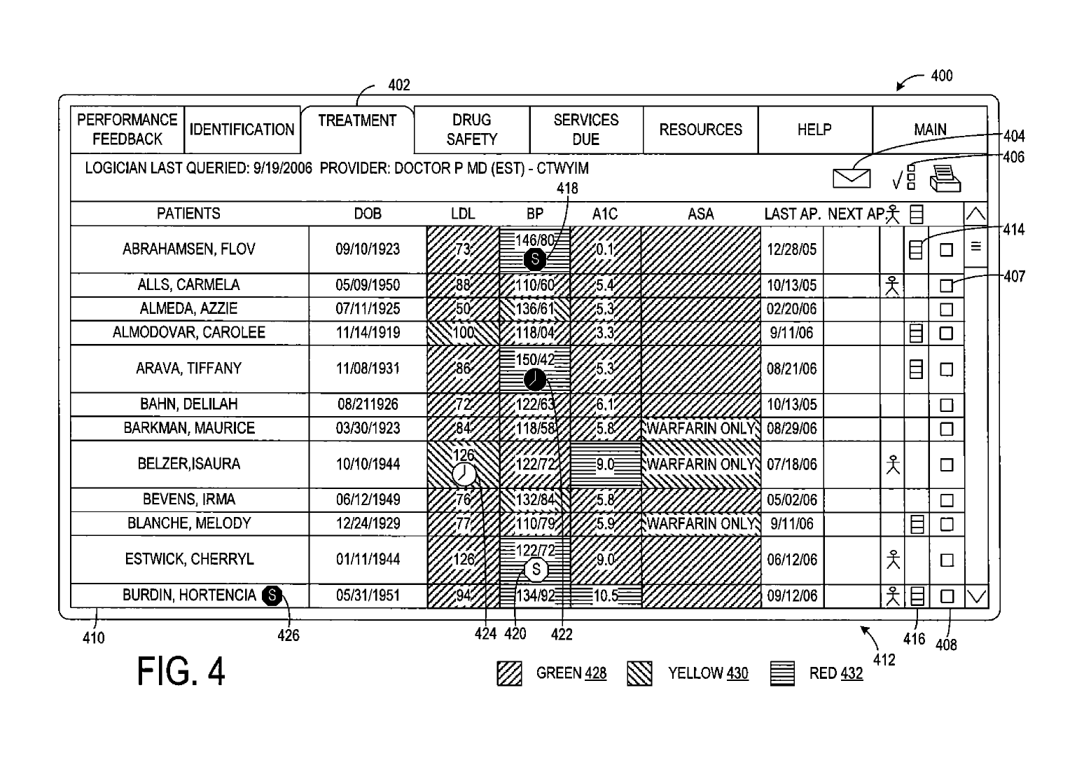

At 208, the routine may display the disease management module selected by the user via the user interface 102. An example disease management module graphical user interface is illustrated and described in more detail below in relation to FIG. 4. At 210, data may be filtered in accordance with user selection, for example, a select group of patients may be identified for filtering the data, a parameter may be identified for filtering the data, etc.

As an example, at 212, the routine receives a user selection of patients to whom patient communications will be sent, via a tab of a disease management module. In one example, a treatment tab may be used, as shown in FIG. 4. The user 112 may select one patient, multiple patients, or all the patients from a list of patients provided in the selected tab.

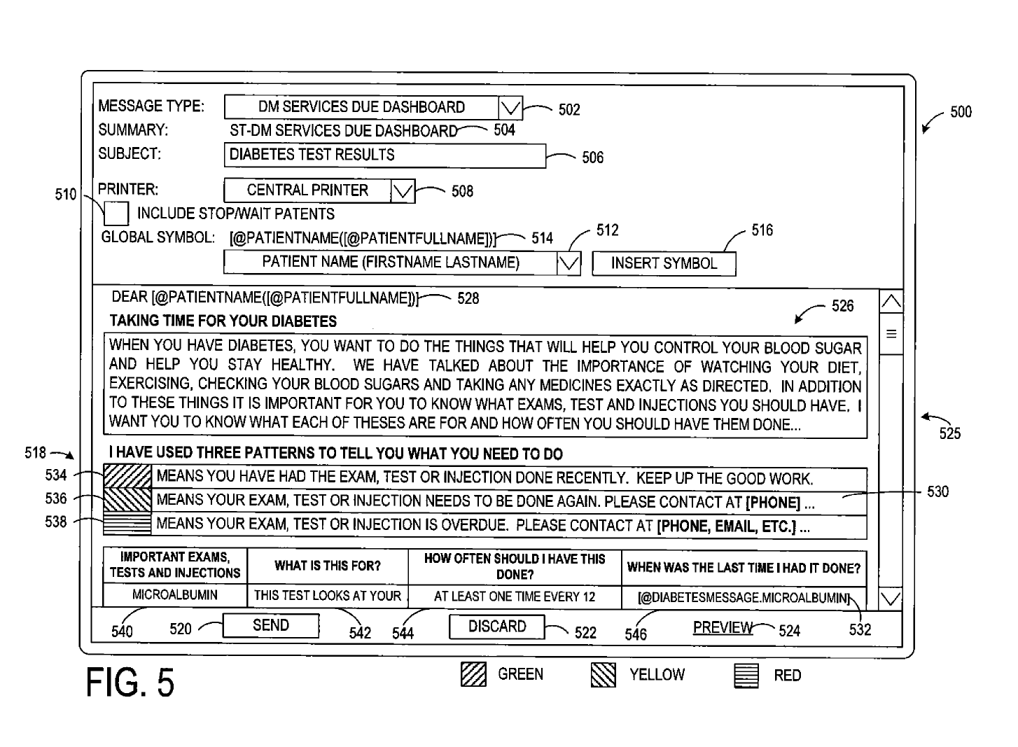

At 214, the example routine describes receiving and displaying the user selection. For example, the user may select to open a patient communication window or interface, such as shown in FIG. 5, for creating patient communications. For example, the routine may receive a request via a particular icon displayed in the patient management module. Further, the routine displays or opens a patient communication window/interface for patient communications.

Referring now to FIG. 2B, at 216, the routine receives the user input of patient communication elements via the patient communication window. The various patient communication elements may include various elements for creating a personalized patient-specific communication from one or more form letters. For example, the patient communication elements may include the message type, subject, various global symbol, various statements that make up the body of the message, responsible physician, date of the communication, etc.

In one example, a global symbol may include a function or a variable that changes as a function of the patient. For example, if a patient communication element is a global symbol for a patient full name, when patient communication is generated, the global symbol may be substituted with the actual full name of the patient. The global symbols may be correlated to patient correspondence information, patient health status information, patient prescription information; patient disease management information, patient action information, etc. Some example global symbols may include: (1) “tobacco-latest status” for a patient's latest tobacco cessation status, (2) “tobacco-latest status date” for the date of a patient's latest tobacco cessation status, (3) “blood pressure” for the latest blood pressure measurement of a patient, (4) “blood pressure status date” for the date of the patient's latest blood pressure measurement, (5) “date of last visit” for date of the patient's last visit to a provider's office, (6) “user first name”, (7) “user full name”, (8) “user home location address line1”, (9) “user home location address line2”, and (10) “user home location city”.

At 218, the routine may receive user selection among the following choices: (1) SEND for executing patient communications, (2) DISCARD for discarding the user selected of entered patient communication elements, or (3) PREVIEW for previewing a patient communication message template.

If the user selects SEND, the routine proceeds to 220. If the user selects DISCARD, the routine proceeds to 222. If the user selects PREVIEW, the routine proceeds to 224.

At 222, the routine discards the user selected and/or inputted patient communication elements, for example by clearing patient communication elements from the data processing system 104 and by clearing the content displayed in an editing pane. The routine may continue at 216.

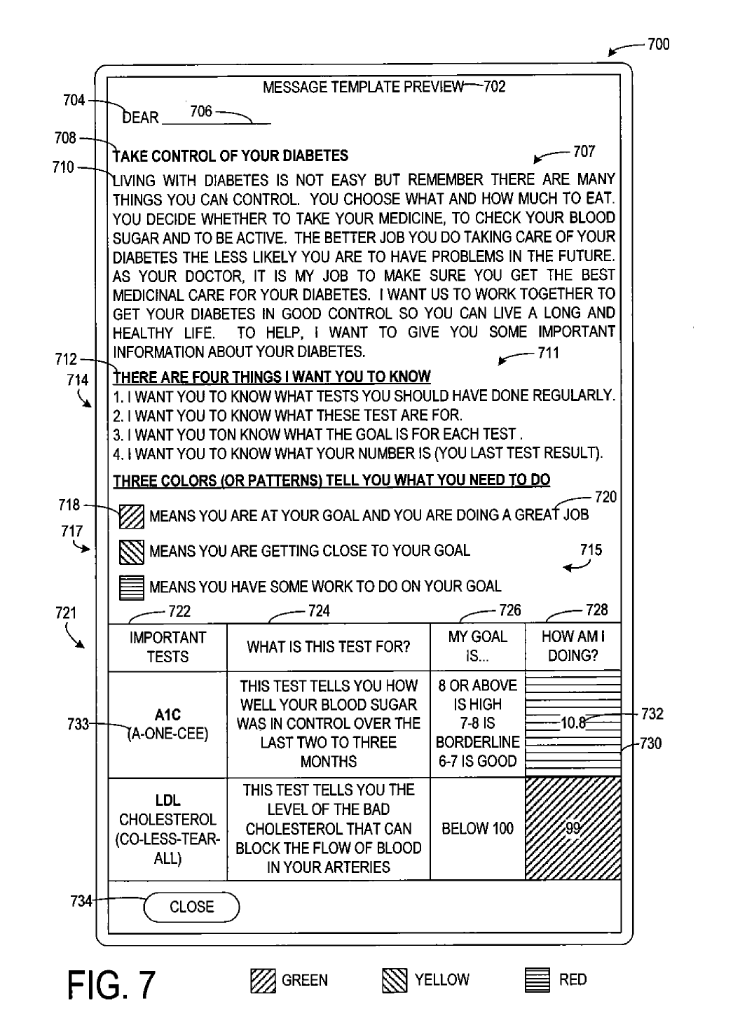

If the user selects PREVIEW, at 224, the routine generates a patient communication message template, for example via the data processing system 104. A preview window may be opened to display a patient communication message template, at 228. A preview of an example custom patient communication message template is illustrated in FIG. 6. The preview may enable the user to confirm that the communication is correct. In addition, an example patient communication message template that includes a predefined patient communication dashboard is illustrated in FIG. 7.

At 230, the routine receives the user input indicating a request to close the preview window. The user may do so by clicking on for example a close selector-button (e.g., 614 and 732) provided in the preview window. At 232, the routine closes the preview window (e.g., 600 and 700) and may continue at 216.

If the user selects SEND, at 220, the routine automatically generates and executes personalized and patient-specific patient communications to the patients selected by the user, using the patient communication message template (e.g., 600 and 700), including one or more patient care status parameters of the patient. The communication may be generated in accordance with a previously-selected patient's preferred communication type, such as a mailing, an electronic message, etc. In one embodiment, the routine may send a secure e-mail, in which the patient receives a notice that a secure e-mail has been sent from a user with health care information.

It is noted that the system may be configured to automatically send communications at various time periods. For example, periodic automatic communications may be sent to a select patient group regarding certain patient care status parameters. For example, an automatic communication may be sent on a predetermined schedule, (e.g. monthly, annually, semi-annually, etc.) and including information regarding a specific health status or patient care parameter. Further, the communications may be automatically sent based on a patient care parameter status. For example, the communication may be sent as a notice regarding an upcoming or overdue appointment or test. Reminders may be automatically set to send based on a predetermined period of time between the event and the last reminder.

As described, the patient care status parameters may include various patient information elements extracted from the EMR databases (e.g., 104) and may contain various physician statements and/or diagnoses based on the patient information elements. The patient care status parameters may be information related to a patient's condition, health status or information related to monitoring or maintaining a patient's condition or health statues. For example, patient care status parameters may be test results, testing requirements, care advice for a condition or health status, etc.

As more examples of patient care status parameters, in some embodiments, patient care status parameters may include (1) a patient's test result, for example the patient's latest troponin test results, blood pressure levels, glucose levels, etc.; (2) care advice to a patient based on a patient's test result, for example care advice based on blood pressure levels; (3) statements telling a patient that he/she is due for an exam, based on the her last exam date or the result of her another exam; (4) statements telling a patient that he/she may have a particular condition, or may be at risk for a particular condition, based on the patient's test results. At-a-glance indicators may be used to improve the viewability and content delivery of the communication. For example, the communication may include color coded information and/or suggestions for care.

In one example, the routine may generate a plurality of communications of various types depending on preferences stored in the databases. For example, the routine may generate communications that not only contain information specific to a given patient, but also may automatically generate the communication in a communication type that has previously been requested by the given patient. Thus, a user may automatically generate e-mails to some patients, and letters to other patients, without requiring specific selections by the user for each patient.

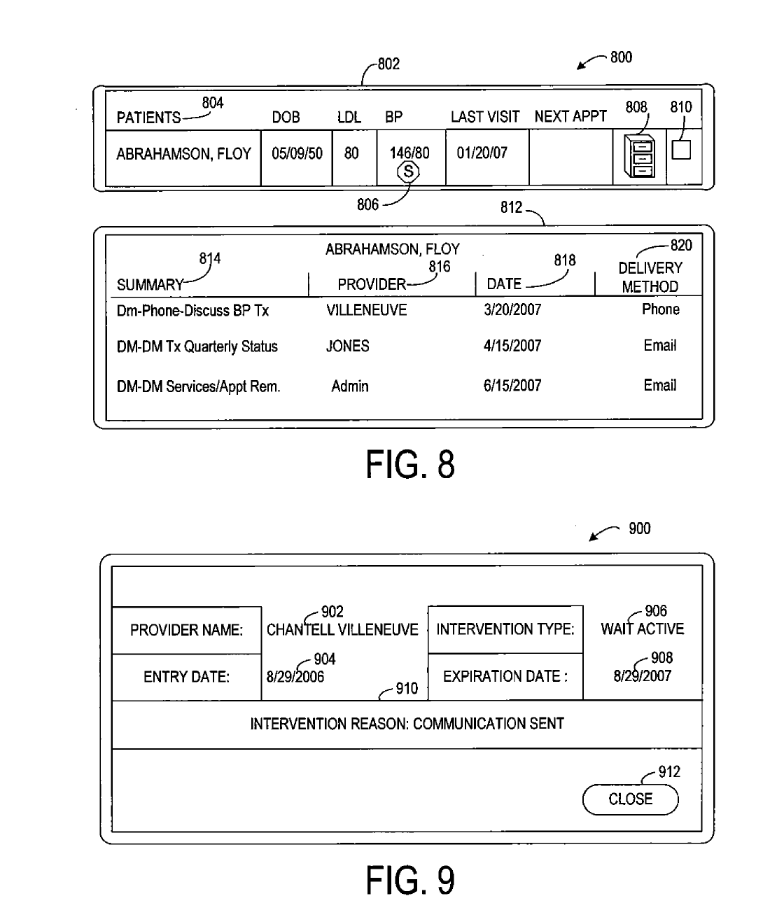

In some embodiments, the routine may generate an audit trail, at 236, of various actions performed using the management system. For example, an audit trail of patient communications may be generated. An example audit trail is illustrated in FIG. 8. The audit trail for example may include any relevant information relating to the patient communication generated and sent (or received) from the client. Further, the audit trail may also include communications between providers, laboratories, etc. As an example, the audit trail may include, but is not limited to, the following information: (1) the name of the care provider who signed and sent the patient communication message, (2) time the patient communication was sent, (3) the type of patient communication sent, for example whether it is an email, a letter, or a phone message, (4) a link to the actual patient communication message, and/or (5) a copy of the actual patient communication message, etc.

At 238, the routine may create EMR documents that document the patient communication, for example via an EMR document generator. The created EMR document may be appended to an EMR record of the patient to whom patient communication has been sent. The routine may end at 240.

The patient management/communication system may facilitate customized patient communication to potentially a large number of patients. The customization of the communications may enable improved health care provider services and enable more patient and provider interaction without increasing the provider burden role. At-a-glance features may further enhance the communications.

FIGS. 3-8 illustrate example graphical user interfaces, also referred to as care provider interfaces, of aspects of the patient management system and method disclosed herein. It should be appreciated that the data used is example patient data for illustrative purposes only. Moreover, although windows and interfaces are provided, additional windows and interfaces may be used without departing from the scope of the disclosure. Further additional fields, user inputs, etc. may be provided without departing from the scope of the disclosure.

FIG. 3 illustrates an example main menu 300 of a patient management system. Menu 300 may include selectors, such as selector-buttons for various disease management modules, such as a cancer screening management module 302, a coronary heart disease management module 304, a diabetes management module 306, a stroke prevention management module 314, and a tobacco cessation management module 316. The main menu 300 may also include drop-down lists, such as provider lists, 308, 310, 312, 318, and 320 which may (in some embodiments) correspond to disease management modules.

It should be appreciated that the main menu 300 may also include various other disease management module inputs, such as selector-buttons and drop-down lists, corresponding to various other disease management modules or interfaces, for example, selector-buttons and drop-down lists for osteoporosis module, sleep apnea module, deep vein thrombosis module, mental wellness module, and pregnancy module, etc.

The disease management module selector-buttons may allow users to open a disease management module corresponding to the disease management module selector-button selected by the user. An example disease management module is illustrated in FIG. 4.

Drop-down lists (or other user selectors) may allow a user to select a display format of a disease management module. For example, the disease management modules may be viewed in a Single-Clinician View or in an Entire-Clinic View. In a Single-Clinician View, the selected disease management module opens with patient data associated with the selected clinician. In an Entire-Clinic View, the selected disease management module opens with data for all clinicians associated with the selected clinic.

The view or display format available in the drop-down lists may depend on the user privilege assigned to the users at the user login. For example, if the user is a clinician, the drop-down lists may provide a view selection that includes a Single-Clinician View under the clinician's name and an Entire-Clinic View for the clinic the clinician is associated with. The clinician may select a Single-Clinician View under his/her name to view the disease management module with patient information for the clinician's patients. Alternatively, the clinician may select an Entire-Clinic View for viewing the disease management module with patient information for patients of the clinician and the entire clinic. In another example, if the user is a support staff, the drop-down lists may provide a selection that may include Single-Clinician View for clinicians the support staff works with in addition to an Entire-Clinic View.

By providing various disease management modules, the patient management/communication system may improve the quality of care provided to patients. In addition, at-a-glance features may enable viewing of patient information for a group of patients with a common condition. This at-a-glance view may allow the user to reference information relating to patient care for other patients with a common condition. Further, by providing Single-Clinician Views and Entire-Clinic Views, the patient management/communication system may provide the user added flexibility by allowing the user to conveniently view patient information for patients for a single clinician or for an entire clinic.

FIG. 4 illustrates an example disease management module 400 of a patient management system. The disease management module 400 may include various tabs, such as tab 402, for organizing the displayed patient information. For example, it may include a performance tab for providing performance feedback information regarding a healthcare provider's performance in providing patient care, an identification tab for providing patient identification information, a treatment tab for providing patient treatment information, a drug safety tab for providing drug safety related information, a services due tab for providing services due information, a help tab for providing various help information regarding how to use or navigate the patient management system, and a main menu tab for bringing the user back to the main menu (e.g., as illustrated in FIG. 3) of the patient management system.

The treatment tab 402 has been selected in FIG. 4 and is the active tab in this example, includes a graphical user interface that identifies or includes patients with the particular disease, diagnoses or equivalent conditions, and/or identifies or includes patients at high risk for the particular condition. The treatment tab 402 may include a patient communication selector-button/icon 404 for opening a patient communication window, a select-all-patient selector-button 406 for selecting all patients displayed, and select-individual-patient check-boxes 407 in the select-individual-patient checkboxes column 408 for selecting individual patients. In addition, the treatment tab may also include a patient name column 410, various patient care parameters columns 412 for display various patient care parameters, and an audit trail selector-button column 414 that includes audit trail selector-buttons 416 for opening patient communication audit trail logs of individual patients.

At-a-glance features, such as intervention tracking icons, may be provided in a disease management module for managing care intervention tracking and/or indicating status of care intervention tracking. For example, in disease management module 400 includes various care intervention tracking icons are illustrated including: a parameter-level expired stop icon 418, a parameter-level active stop icon 420, a parameter-level active wait icon 422, a parameter-level expired wait icon 424, and a patient-level expired stop icon 426.

As described in more detail below, intervention tracking may be used to signal whether an action, such as sending a communication, should be initiated for a patient. In some embodiments, the intervention tracking may document the provider's plan and prevent disruptive or repetitive communications being sent to a specific patient who is already under the care of a provider. For example, in some embodiments, the care provider may be actively addressing a specific condition, and thus a general communication for the condition would be inappropriate. As such, intervention may track or document a provider's care.

Intervention tracking further may support appropriate measurement and reporting of clinical performance, for an individual healthcare provider, clinic or entity. When setting a “stop”, the healthcare provider indicates the reason that further clinical intervention is not appropriate for that specific patient (e.g., on hospice or patient refuses care). By doing so, the application will exclude the patient from communication, but may (or may not depending on user set up) also be set to remove the patient(s) from inclusion in performance measurement. Thus, interventions may be accurately configured to enable a provider to meet a set of care requirements or quality measures to qualify for certain financial incentives or rewards (e.g., pay-for-performance programs such as Physician Quality Reporting Initiative (PQRI) from the Center for Medicare and Medicaid Services or other provider reporting system). For example, the intervention tracking may enable patients to be properly grouped such that patients are properly included and/or excluded from communications or groupings. Thus, interventions may be accurately configured to enable a provider to meet a set of care requirements or quality measures to qualify for certain financial incentives.

Moreover, in some embodiments, intervention tracking may be used to prevent sending communication to a patient that would otherwise receive the intervention, such as a communication due to other extenuating circumstance. In this way, the intervention tracking operates to enable a user to automatically include individual patients for an action, while excluding those that such action would be undesirable. The intervention tracking prevents a user from manually checking individual patient records to confirm that the care action should occur and prevents unnecessary, duplicative, or undesirable care actions and/or communications being sent to a patient or group of patients.

For example, in some embodiments, a disease management module may include icons for two types of intervention tracking: stops and waits. The stops and waits may be active or expired phase. For example, a disease management module may provide (1) intervention tracking icons for active stops, which may indicate to the users not to pursue treatment at this time; (2) intervention tracking icons for expired stops, which may indicate to the users that the expiration date for a stop has passed and treatment should now be pursued again; (3) intervention tracking icons for active waits, which may indicate that the patient management/communication system is waiting for certain predetermined conditions to be satisfied or certain pre-determined events to occur, such as patient has take certain actions, certain lab results have come out, certain lab results meet certain pre-determined threshold or criteria, and/or other treatment component have occurred or reached certain pre-determined threshold or criteria; and/or (4) intervention tracking icons for expired wait, which may indicate that the expiration date for the wait has passed and treatment should now be pursued again.

Intervention tracking may be placed at a patient-level or at a parameter level. The intervention tracking may be applied based on conditions of the patient, conditions of the patient's care, and/or events corresponding to the patient. Patient-level intervention tracking may apply to the individual patient. For example, when “stops” are placed on a patient (a patient level intervention tracking icon is illustrated by icon 426), the tracking icon may signal the user, other users and the system that no care actions should be initiated for that patient through the patient management system, possibly because he/she is suffering from a more acute or chronic overriding condition, e.g. cancer, and/or is temporarily unavailable, e.g. temporarily out of the country. As another example, a “wait” may be placed on a patient to indicate that the patient is under a provider's care for a specific condition. As a more detailed example, a provider may initiate a new medication in response to an elevated blood pressure parameter. The provider user may enter a “wait” for a specified period of time (e.g. 4 week) for the blood pressure parameter. The wait may remain active until a new blood pressure is entered in the system or the period of time expires (e.g. 4 weeks passes with no action). In some embodiments, the wait may automatically be removed once the criterion for including the wait has occurred. For example, the wait may be automatically removed once the needed test, 1a, medication, or appointment occurs. During the waits active phase, the patient may be excluded from a group of patients which are identified for action based on the elevated blood pressure parameter. Once the wait expires, and is in an inactive phase, the patient may automatically be included in a group of patients which are identified for action based on the elevated blood pressure parameter.

Parameter-level intervention tracking may apply to the individual patient care parameter. For example, when waits are placed on a patient care parameter, such as a patient's BP, it may mean that the patient management system may be waiting for certain pre-determined conditions to be satisfied or certain events to occur before initiating any treatment for the particular patient relating to the patient's BP patient care parameter. In some examples, patient-level intervention tracking may have priority over all parameter-level intervention tracking. For example, the users 112 may not be able to set parameter-level interventions while a patient-level stop is active.

For example, the intervention icons 418, 420, 422, and 424 may be parameter-level intervention icons. More specifically, the intervention tracking icon 418, 420, and 422 may be placed on the BP patient care parameter individual patients, while the intervention tracking icon 424 may be placed on the LDL patient care parameter of a patient. The intervention icon 426 is a patient-level intervention tracking icon, representing intervention tracking is placed on individual patients.

Stops and waits may be set for a specific duration, for example 60 days. When the stops and waits expire, the intervention tracking icons may change in their graphical representation, for example turn gray, for a period of time, for example 30 days, after which they may disappear.

In some examples, the intervention tracking icons may graphically represent the intervention tracking status. For example, the appearance of an intervention tracking icon, such as its shape and/or color, may change when the intervention tracking status it represents changes. As an example, the intervention tracking icon may be a stop indicator, a wait indicator, etc. For example, the intervention tracking icon may be shaped as a stop sign or clock. Color-coding may indicate current action level for the intervention.

As an example, and not as a limitation, in some embodiments, an active stop (e.g., 420) may include a black S placed inside a white octagon that is surrounded by a red background 402C When an active stop (e.g., 420) is expired, it may change its appearances to become an expired stop (e.g., 426), by for example turn “gray”. The expired stop (e.g., 426) may include a white S in a red octagon that is surrounded by a gray background. For another example, an active wait (e.g., 422) may include a two-toned blue clock with white hands, and the clock is placed in a red environment. When the active stop expires, it may changes to become an expired wait (e.g., 424). The expired wait (e.g., 424) may include a white clock with black hands in a yellow, and the clock is placed in a yellow environment.

Further, the treatment tab 402 may include at-a-glance features, such as color codes for coding status of patient care parameters. For example, a green color 428 may be provided to indicate that the patient care parameter is in compliance with recommended care, for example, the test is not over due or the test result is below the evidence-based, guideline-recommended target. Yellow 430 may indicate that a test might be coming due shortly or that a test result is slightly or moderately above target. Red may indicate a concern such that a parameter might be overdue or a result might be significantly above target. White may indicate that the guideline or evidence does not apply, or there is insufficient information available, for example, a patient has had the exam, test or shot done recently. The

The at-a-glance features may also be displayed on a patient communication, such as shown in FIG. 5. For example, a yellow color 536 may indicate that a patient's exam, test, or shot needs to be done again in the next 90 days, and that the patient should call to schedule an appointment. A red color 538 may indicate that a patient's exam, test or shot is overdue or the patient has not had this test done, and that the patient should call to schedule an appointment.

Returning back to FIG. 4, a user may select one, multiple, or all patients displayed for patient communication. For example, the user may check the checkboxes in the select-individual-patient checkbox column 408 for selected patients for which a communication should be generated. Alternatively, the user may click on the select-all-patient selector-button 406 to select all patients displayed in the Patient Name column 410.

Once the patients to whom communication will be sent are selected, the user may click on the patient communication dialog box to open a patient communication window.

An audit trail selector-button 416 may be provided in the audit trail column of a patient if patient communications have been sent to the particular patient and an audit trail or patient communication log has been generated by the system. The user may view, and the system may display, the patient communication audit trail for the particular patient when the audit trail selector-button 416 is selected (see example patient communication audit trail log in FIG. 8).

In this way, the system may generate a plurality of personalized or customized patient communication messages for selected patients having a common condition, where the communication may contain patient specific parameters, such as care recommendations, and/or advice. In some embodiments, such communications may include at-a-glance features to quickly and clearly communicate care information.

FIG. 5 shows an example patient communication window 500 having predefined patient communication dashboards with patient care parameters. As discussed above, the patient care parameters may be health-care related information specific to a patient, for example, the patient care parameters may include various care status elements and/or patient information elements extracted from EMR databases.

The patient communication window 500 may include a message type drop-down-box 502, a summary field 504, a subject entry field 506, and a printer drop-down list 508, an include stop/wait patient check-box 510, a global symbol field 512, a global symbol drop-down list 514, a INSERT SYMBOL selector-button 516, a message editing pane 518, a SEND selector-button 520, a DISCARD selector-button 522, and a PREVIEW selector-button 524. Other fields, selector buttons, etc. may be provided without departing from the scope of the disclosure.

The message type drop-down box 502 may include a list of types of patient communication messages that the user may select. The user may select from the list to create a custom message or a pre-set message. As an example, it may be possible to select one or more of the following patient communication messages from the illustrated dashboard: (1) a custom message, (2) a missed lab message, (3) a service due message, (4) an unable to reach message, (5) a test reminder message, or (5) a phone note. The user may also select from the list various predefined dashboards containing predefined patient communication messages. For example, the user may select a DM Services Due dashboard containing a predefined patient communication message relating to diabetes mellitus service due, or a DM Treatment dashboard for a predefined patient communication message relating to diabetes mellitus treatment.

The summary field 504 may provide a brief description of the type and/or purpose of the message created. For example, the summary field 504 may indicate that the message includes a standard diabetes mellitus services due dashboard. The subject entry field 504 may include an entry box for the user 112 to enter message subjects. For example, the user 112 may enter “Diabetes test results” in the subject entry field 504, indicating that the patient communication is concerning the patient's diabetes test results. The printer drop-down box 508 may include a drop-down list of printers that the user 112 may select to print the created patient communication messages. For example, the user 112 may select a “Central Printer” for printing personalized patient-specific patient communication messages.

The Include Stop/Wait Patients check-box 510 may include a check-box configured to, when checked, include all patients selected by a user even if the patient a stop/wait status has been placed on the patient. The global symbol drop-down box 512 may include a global symbol drop-down list (not labeled) for various global symbols that the user 112 may select to insert into the patient communication message. The drop-down list may include global symbols as described above. Thus, for example and not as a limitation, the global symbols may include: user first name, user full name, user home location address, latest status, latest status date, a reading of a lab test, a reading of a lab test above a certain threshold, and a reading of a lab test below a certain threshold, etc.

The global symbol field 514 may indicate the global symbol that will be inserted to the patient communication message. The INSERT SYMBOL selector-button 516 may be configured, so that when selected, the patient communication window 500 will insert the global symbol selected by the user to the patient communication message in the message editing pane 518.

By providing a global symbol that may be inserted in a patient communication message to represent a patient communication element, it may allow the patient communication element represented by the global symbol to change as a function of the patient to whom the patient communication is directed. For example, if a global symbol for patient's full name is inserted into a patient communication message template, each patient communication later generated using the patient communication message template will include the name of the patient to whom the patient communication is directed. Further, by providing pre-defined patient communication dashboards, it may significantly reduce the time a user may spend creating patient communication messages.

The message editing pane 518 may include a predefined dashboard, such as DM Services Due Dashboard 525, containing a predefined patient communication message template relating to services due for diabetes mellitus patients. The message editing pane 518 may be configured to receive and display various patient communication elements entered or selected by the user. For example, the user may type, insert, edit various components or elements of a patient communication message.

The dashboard 525 may include various global symbols. For example, it may include a @Patient Name@(PatientFullName) global symbol 528 for inserting the name of the patient to whom the communication will be sent. It may include @PCPHomeLocPhone global symbol 530 for inserting the care provider's phone number. It may also include a @DiabetesMessage.Microalbumin global symbol 532 for inserting the last microalbumin test date.

The dashboard 525 may further include at-a-glance features, such as color codes, coding for status of patient care parameters, such as Green 534, Yellow 536, and Red 538. Green 534 may indicate that there are no issues, for example, a patient has had the exam, test or shot done recently. Yellow 536 may indicate that a patient's exam, test, or shot needs to be done again in the next 90 days, and please call for an appointment. Red 538 may indicate that a patient's exam, test or shot is overdue or the patient has not had this test done, and please call to schedule an appointment.

The dashboard 525 may also include textual information, such as sentences, paragraphs and tables, for relaying to the patient information relating to his/her care. The textual information may in general be written in layman language and/or explained in layman language, so that a patient may easily understand. For example, medical acronyms, such as DM, ASA, BP, LDL, DOB, which may be difficult for the patient to comprehend, may be automatically replaced, if possible. Medical exams, such as a microalbumin test, may also be explained in layman terms so that a patient may understand the information, what the information may indicate, and the meaning of test results.

The dashboard 525 may for example include a table relaying a patient's relevant exams, tests and shots. The table may include various columns. For example, an “Important Exams, Tests and Shots” column 540 may be included to list important exams, tests, and shots of a patient. A “What is this for?” column 542 may be included to provide interpretive information regarding the important exams, tests or shots listed in column 540. A “How often should I have this done?” column 544 may be provided to indicate how often a patient may need to have the exam, test or shot. A “When was the last time I had it done” column 546 may be provided to indicate when was the last time the patient had this exam, test or shot done.

The dashboard 525 may further include a general information section 526 for relaying certain general information relating to how to manage the disease condition of the patient. The general information section 526 may include a short title (not labeled), and a body (not labeled). The general information section may, for example, explain to a patient things that the patient may do and know improve his/her condition. The general information section 526 may also provide a patient with a brief introduction of the patient communication message, such as what is included in the patient communication message.

After creating the communication, a SEND 520 selector-button may be configured to allow a user to send the composed message to individual patients selected by the user, for example by printing the messages, forwarding the messages to patients via email, sending out automated phone messages, and faxing the messages to the patients, etc. Further, in some embodiments, a DISCARD selector-button 522 may be configured to allow the user to discard the patient communication message. Finally, the PREVIEW selector-button 522 may be configured to display a preview of the composed patient communication message.

FIG. 6 illustrates a preview of an example custom patient communication message template 600 to a patient created via a patient communication window (e.g., 500). The example preview of a custom patient communication message may include a title 602 indicating that is a preview of a patient communication message. The preview may include a patient greeting 604, a space for individual patient's name 606. The preview 606 may further include a message body 608. The message body 608 may include one or more statements with patient information, including patient care information related specifically to the patient. For example, a patient care parameter, test result, is included in the example patient communication message (“Your last result was 124.”). Thus, patient care information may be pulled from an individual's record to customize the communication specifically to the individual patient. The preview 600 may also include the name of the clinician 612 from whom the patient communication is originated.

The message template preview may be reviewed by a user for individual patients to ensure that the message is in the form desired. Additional options for viewing and/or editing the message may be provided. Selector buttons may enable a user to edit, confirm, or close 614 the preview.

FIG. 7 is a preview of an example patient communication message template 700 created via a patient communication window (e.g., 500) using a predefined patient dashboard. The preview 700 may include a title 702 indicating that this is a preview of a patient communication message template. The preview 700 may include a patient greeting 704, a space for a patient's name 706. The preview 700 may also include a general advice and information section 707 for providing general advice and information to the patients regarding his/her condition, for example regarding how to manage his/her condition. The general advice and information section may include a title 708 and a body 710.

Summary section 711 may be provided for summarizing information a care provider desires to communicate to the patient through the patient communication. The summary section 711 may include a title 712 and a list of things that a patient need to do, e.g. testing, or what a care provider would like the patient to know, e.g. condition information.

The preview 700 may also include an at-a-glance feature explanation section, such as a color code explanation section 715, explaining to the patients what the various color codes used in the patient communication message to a patient mean. The color code explanation section 715 may include a title 716 and body 717. The body 717 may include various color codes 718, such as green, yellow, red, and blue. The body may also include explanation for what the color codes mean 720. For example, green may mean that the patient is at his/her goal and he/she is doing a great job, yellow may mean that the patient is getting close to his/her goal but needs to keep working on those things that he/she can control (e.g., what he/she can eat, how much exercise he/she gets, testing blood sugars and taking medications), red may mean that the patient may have some work to do to get to his/her goal and if the patient has not been seen by the care provider, he or she should call the care provider's office at a certain number, blue may mean that the patient's test is overdue or the patient has to have this test done, and please call the care provider's office to schedule an appointment.

The preview 700 may also include a table 721, for example a table for providing patient information regarding important tests. The table may be written in simple terms so the patients may easily understand the health-related information. Pronunciation keys, such as 733, may further enable ease of understanding and improve communication between the patient and the provider when the patient wants to discuss such information. As an example, table 721 may include (1) an “Important tests” column 722 listing various relevant lab tests and the pronunciation key for such tests, (2) a “What is this test for?” column 724 explaining to a patient what the tests are, (3) a “My goal is . . . ” column 726 explaining to a patient what the patient's goal should be, (4) a “How am I doing?” column 728 showing how a patient is actually doing.

The patient communication messages may include the at-a-glance features, such as color coding. For example, The “How am I doing?” column 728 include color codes 730 to give a patient at-a-glance of how he/she is doing, and the value of the patient's most recent test result 732. For example, in this prophetic patient communication, the patient's glycated hemoglobin (A1C) test value is 10.8 and is color coded red, indicating that the patient has some work to do to get to his/her goal, and if the patient hasn't seen the patient's physician in the last three months please call the physician's office. The patient's LDL level is 99 and is colored green, indicating that the patient is at his goal and is doing a great job. The patient's blood pressure is 134/86 and is colored yellow, indicating that the patient is getting close to his/her goal but needs to keep working on the things the patient can control.

The preview 700 may also include a close selector-button 734 for closing the preview window 700 and return to the previous patient communication window. In other examples, the table 701 may also include a “How often should I have this done?” column (not shown) explaining to a patient how often should he/she have the tests listed in the important test column 722 done.

By providing patient communication and interpretive information to patients that are written in layman terms and color coded, it may be easier for the patients to comprehend the information and actions the patient should take. For example, a patient may easily understand what A1C is when he/she is told “This test tells you how well your blood sugar was in control over the last two to three months.” Further, by color coding the various patient care parameters, a patient may have an at-a-glance view of how they are doing as the color coded patient care parameters. For example, if a patient's A1C test result is coded red, LDL test result is coded green, and BP test result is coded yellow, the patient will in general know immediately, without trying to figure out what the test result values mean, that he is not doing so well with his A1C, he is doing well with his LDL, and he is getting close to his goal for BP.

FIG. 8 illustrates an example patient communication audit trail log 800 created and displayed by an audit trail feature of a patient management/communication system. As described above, a communication may be created for a specific patient. The creation of the communication may be documented and retained as part of the patient's record. For example, a file cabinet or other storage icon may be provided to enable access to the various communications sent to (or received from) the patient. Further, as described in more detail below, intervention tracking icons, such as waits or stops, may be applied to such communications. Such waits or stops may also be recorded in the patient's record.

As shown in FIG. 8, at 802, interfaces may be provided which provide various care management information for a provider. Such information may include, but is not limited to, the name of the patient, date of birth, address, last visit, next appointment, the provider, test results, diagnosis, etc. As shown at 802, such patient records, may include intervention indicators, such as intervention icons 806. Further, an audit log indicator may be linked to the patient record, such as the filing box icon 808. The user may select to review the patient record by using selector buttons 810 or by linking to the audit log through an audit log indicator.

For example a patient management/communication system may automatically generate a patient communication audit trail log for each patient for which patient communications have been sent. The users may open a patient communication audit trail log (e.g., 812) for a patient by clicking on the audit trail or audit log indicator 808 corresponding to the patient in a disease management module (e.g., 400).

The audit log may include a summary of the communication or action, as indicated at 814, the provider linked with the communication or action, at 816, the date such communication or action was sent or received, 818, and the delivery method, 820. It may provide a provider column 804 for identifying the care providers (e.g., physicians) who have sent the patient communication. For example, in the second row of the audit log shown at 812, a quarterly status report was sent via email to patient Floy Abrahamson under the direction of a care provider Jones on Apr. 15, 2007. In some embodiments, the user may directly access the communication or a more detailed action report by selecting the desired communication or action.

FIG. 9 illustrates an example intervention detail window 900 for a patient (e.g. 112), opened by clicking on an intervention icon (e.g., stops/waits intervention icons 418, 420, 422, 424, and 426 as shown in FIG. 4) of the patient displayed in for example a treatment tab (e.g., 402C) of a disease management module. The intervention detail window 900 may allow a user to view various details of the patient communication. Intervention parameters may be set by a provider.

The intervention detail window 900 may include a provider name 902, entry date 904 for the date of entering or setting the intervention tracking, an intervention type 906 indicating the type of intervention tracking (e.g., active wait, expired wait, active stop, expired stop, etc), an expiration date of the intervention tracking 908, and an intervention reason section 910 providing reasons for the intervention tracking (e.g., patient communication sent). Other fields and selection inputs may be provided, including but not limited to, open field for notes, a selection icon section, an at-a-glance feature coding option, a close button 912, etc.

As described above, intervention tracking may monitor care actions which occur based on a patient's care parameters. For example, as described above, intervention tracking icons, such as a stop may signal users that a disease management/prevention target has changed based on a provider's preference or decision. Other intervention tracking icons may signal that an action has been taken by a provider (provider has already intervened) and the provider's intervention needs time to be effective. As another example, the intervention tracking icon may be based on a decision or care provider's actions which identify that additional time is necessary before the patient is included in the group because another action is warranted. Some intervention tracking icons, such as stops, may require a provider to remove the icon and bring the patient back into the general group, while others may automatically expire (such as a wait) after a set time period. The time period or limit may be preset or may be set by a provider. For example, depending on the intervention tracking, the period may be automatically set to expire after a specific period of time, such as a time period, e.g. a month, a number of weeks, etc., the next appointment, or some time period for a medication or provider intervention to take effect. Thus, it should be appreciated that the period may be a variable time period based on a type of intervention.

Some intervention tracking may be considered to operate as an exception or exclusion parameter. For example, care actions, such as communications, which would be directed toward a group of patients based on a care parameter, may exclude a specific patient due to the use of an intervention parameter. As an intervention parameter, communications to a specific patient may be prevented (e.g. a stop), or temporarily delayed (e.g. a wait). For example, communications which are no longer relevant to a patient or which should not be sent to a patient are tagged through use of the intervention parameter. Although intervention tracking is used as the example intervention parameter, other intervention parameters are possible and are within the scope of the disclosure. Moreover, the intervention parameter may prevent communication being sent to a patient (patient-specific intervention parameter), may prevent certain types of communications being sent to specific patients (topic-specific or parameter specific intervention parameters), may prevent certain information being requested or communicated in communications to a patient, may prevent communications to a group of patients (group-specific intervention parameter), etc.

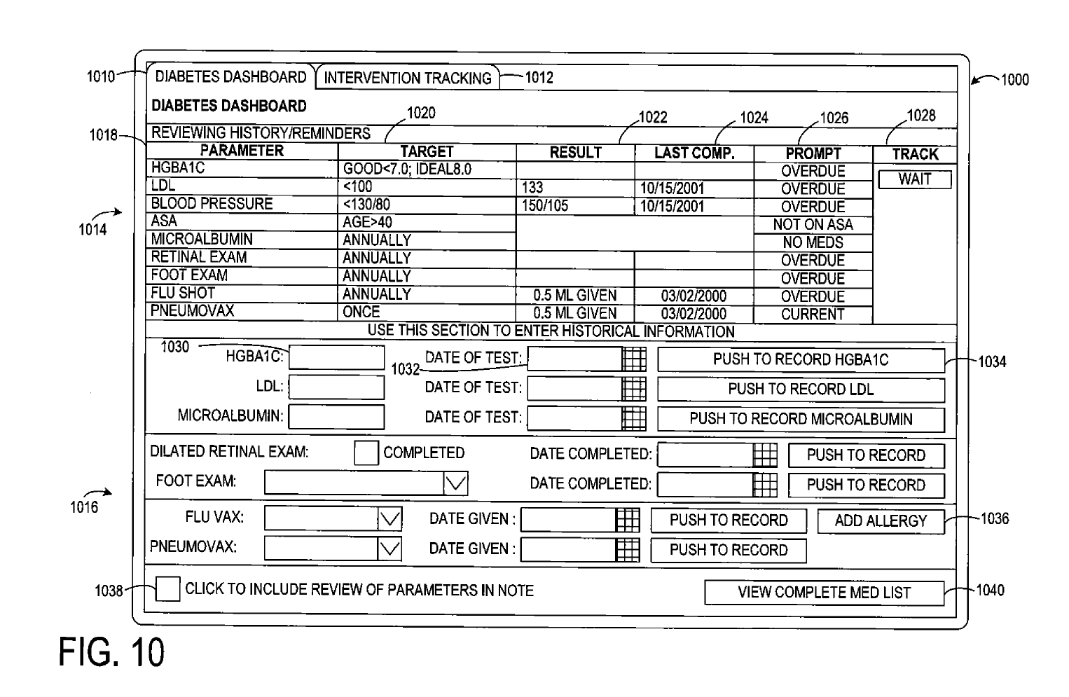

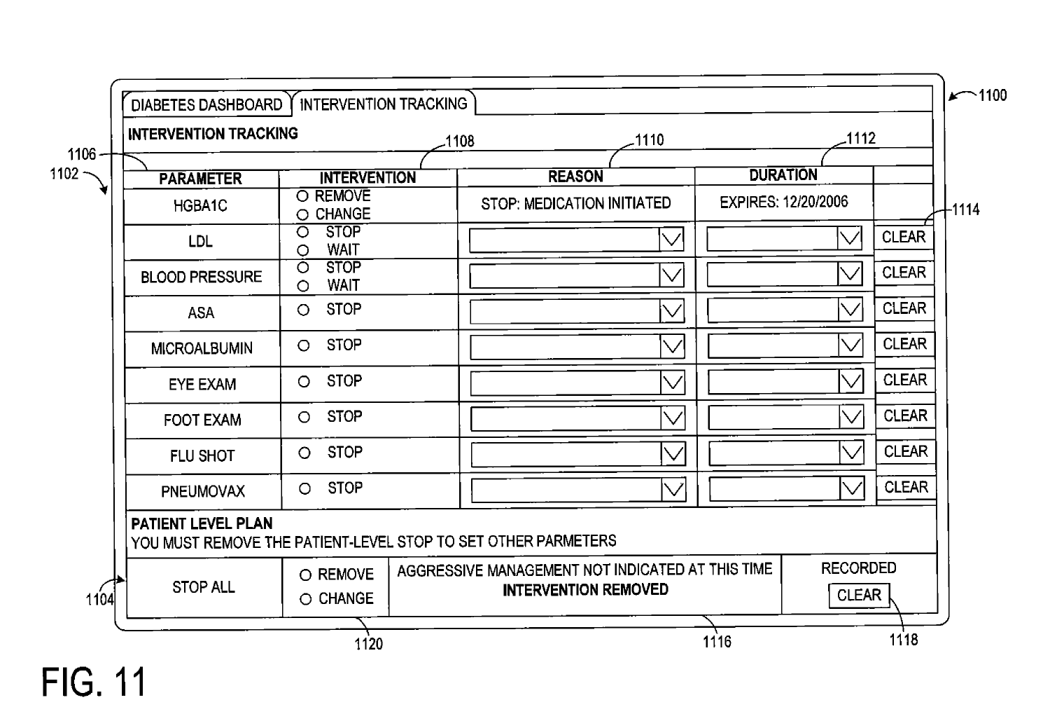

FIG. 10 illustrates an example intervention tracking dashboard 1000 of an example diabetes disease management module, showing an active main menu 1010 for providing the users at-a-glance views of a patient's status with regard to various patient care parameters or patient treatment parameters. The intervention tracking dashboard 1000 may also include an intervention tracking page 1012 for example, which may enable a user to enter, modify, or remove intervention tracking. Further details of an example intervention tracking page 1012 is illustrated in FIG. 11.

Referring back to FIG. 10, main menu 1010 may include various sections. For example, the menu may include a “Reviewing History/Reminders” section 1014, a “Use this section to enter historical information” section 1016. In addition to a PARAMETER column 1018 for listing various patient care parameters or patient treatment parameters, a TARGET column 1020 for listing targets corresponding to the patient care parameters listed in column 1018, a RESULT column 1022 for listing test results of the various patient care parameters, for example the latest test results, a LAST COMPLETED column 1024 for listing the date of the test results, for example the latest test date, and a PROMPT column 1026 for indicating the status of the various patient care parameters, a TRACK column 1028 may be provided to indicate tracking status. The tracking status provides at-a-glance views of interventions at a patient/parameter level.

Additional at-a-glance features may be provided and are described here for purposes of illustration. Such at-a-glance features may be infused through each of the interfaces and communications, creating a uniform system which enables easy and quick reference. As an example, the PROMPT column 1026 may be color coded. A red color code may indicate that there may be an issue as regard to the patient care parameter and special attention may be needed. For example, the test result of the patient care parameter is over due, the patient may have a drug interaction, and the patient may not be take medications the way he/she should, etc. A green color code may indicate that there is no issue with the patient care parameter, for example, the patient's vaccine is current, and the patient's test results are within normal range, etc.

The “Use this section to enter historical information” section 1016 may include various entry boxes, for example an entry box 1030 for entering a patient care parameter level, an test date entry box 1032 for entering the date of the test for obtaining the patient care parameter level. The section 1016 may also include various record buttons, for example record button 1034, for recording the patient care parameter level value and the test date for the patient care parameter. These fields may be automatically or semi-automatically populated from the EMR database in some embodiments. In other embodiments, a user may fill these fields. Furthermore, the section 1016 may include fields for other health-related information, including various other icons, selector-buttons, and check-boxes, such as an allergy selector-button 1036 for opening an interface for adding allergies, a “Click to include review of parameter in note” check-box 1038 for including review of parameter in note, and a “View complete medication” selector-button 1040 for viewing a complete list of the patient's medication.

The intervention tracking dashboard 1000 may allow the user at-a-glance views of various patient care parameters of a patient. It may also allow the user to add, remove, or modify various patient care parameters of a patient with relative ease. In addition, at-a-glance features, such as color coding status of patient care parameters (e.g., color code the PROMPT column 1026) may allow the users to know relatively quickly which patient care parameter is in need of attention. For example, when the LDL status is coded red, the users may know relatively quickly that the patient's LDL needs attention, without even reading through test results corresponding to the LDL and without trying to figure out what the test results mean.

FIG. 11 illustrates an example intervention tracking page 1100 that may allow the users to set, remove, and edit intervention tracking with relative reduced expenditure in time and effort.

The intervention tracking page 1100 may include an intervention tracking interface 1102. The intervention tracking page may enable setting, removing, and/or editing intervention tracking at the patient care parameter-level, that is, for individual patient care parameters. The intervention tracking page 1100 may also include options 1104 for setting, removing, and/or editing intervention for all or a group of patient care parameters of a patient.

The parameter-level plan 1102 and the patient-level plan 1104 may include various columns. For example, it may include (1) a PARAMETER column 1106 for listing the various patient care parameters, such as glycated hemoglobin (HbgA1c) level, cholesterol (LDL) level, blood pressure, aspirin therapy (ASA), microalbumin level, eye exam, foot exam, flu shot, and pneumococcal vaccine (e.g., Pneumovax).

The parameter-level plan 1102 and the patient-level plan 1104 may include an INTERVENTION column 1108 for selecting/deselecting the type of intervention tracking, e.g. select/deselect a stop or wait for a specific care parameter and/or remove or change a current intervention tracking indicator. For example, if an intervention tracking has been set for a patient care parameter, the INTERVENTION column 1108 corresponding to the patient care parameter may provide a check-box for removing the intervention tracking and a check-box for changing the intervention tracking. If no intervention tracking has been set for a patient care parameter, the INTERVENTION column 1108 corresponding to the patient care parameter may provide a check box for adding a stop intervention tracking and a check-box for adding a wait intervention tracking to the patient care parameter.

The parameter-level plan 1102 and the patient-level plan 1104 may also include a REASON column 1110 that includes entering or selecting reason for changes in intervention tracking of the patient care parameter.

The parameter-level plan 1102 and the patient-level plan 1104 may also include a DURATION column 1112 that includes entry boxes or drop-down selection-boxes for the users 112 to enter or select the duration of the intervention tracking. When the duration of the intervention tracking has been entered or selected, an expiration date for the intervention tracking set may appear and replace the entry box or the drop-down selection-box.

The parameter-level plan 1102 and the patient-level plan 1104 may also include a CLEAR column 1114, 1118 that includes clear selector-buttons for clearing the various entries made by the users in the other columns of the parameter-level plan 1102 that correspond to a patient care parameter of the patient. Additional fields may include, but are not limited to remove/change field 1120, an explanation field 1116, etc. It should be appreciated that various at-a-glance features, such as system color coding may be incorporated into the intervention tracking page.

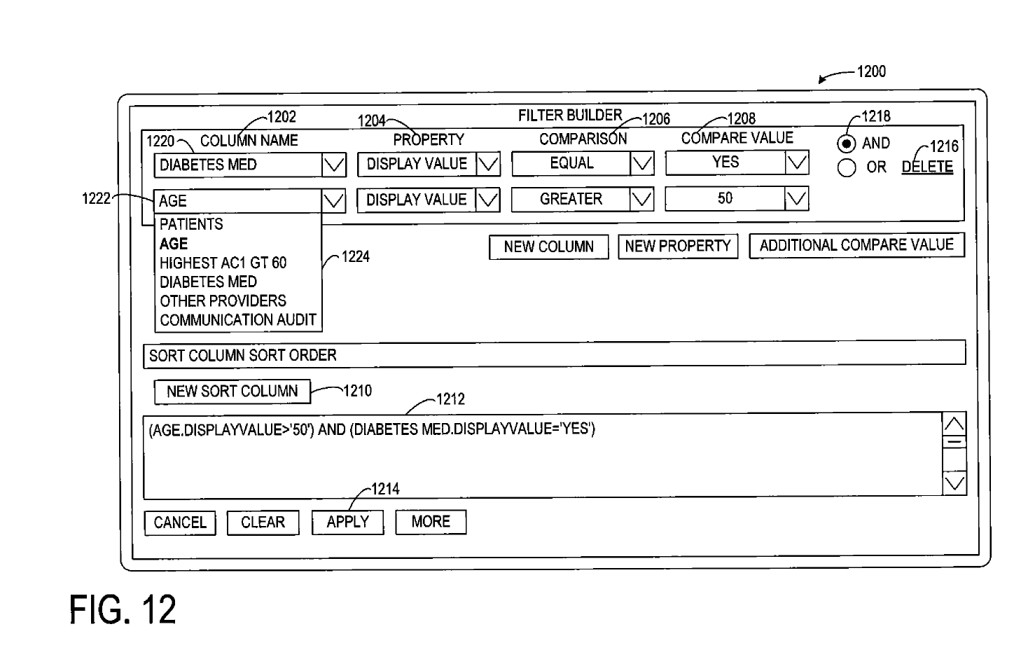

In some embodiments, additional interfaces may be provided to enable a user to sort patient data to access specific data or review a specific set of patient care parameters. The system may enable customization of the sorting to enable a user to selectively sort the data according to selected criteria and in a user-selected order. FIGS. 12-15 illustrate example filter builder interfaces and filter review windows for use to enable searching of the system, the patients, and the care parameters. As used herein, a filter may be composed of one or more search queries and may be predefined or custom built by a user or administrator.

As a first example, FIG. 12 illustrates an example filter builder interface for a patient management/communication system. It should be appreciated that the filters and building of filters may be a locked feature which may be altered through an administrative interface. Thus, an administrator may allow access to specific individuals to build filters and/or use the filters. As an example, a first permission level may enable a user to create, name and use a personal filter, which when saved may be a predefined personal filter. With such a permission level, the user may not be able to create a global filter. In contrast, another permission level may enable a user to create and name filters for global use. Such filters created for global use may be viewed by other users as a predefined filter. Further, some users may have little or no access to the filtering.

In this example interface 1200, the user may select a parameter for filter, (e.g. column name 1202), a property 1204, a comparison, 1206, and a compare value selector 1208. For example, the user may select from a group of predefined column headings, including patient data, care provider parameters, medication parameters, communications, etc. As shown, a user may select the column heading from a pull-down menu 1224 including: patients, age, highest AC1 GT 60, diabetes med, other providers, communication audit, etc. In the example, diabetes med has been selected at 1220 and age at 1222. The user may then select how to search the selected data through search query selection, property 1204, comparison 1206, value 1208, and selection of an “and” or “or” search at 1218. The user may select to delete a prior search at 1216, new sort column 1210 or add in additional columns, property, compare values as indicated by the selection buttons on the example interface. Further views and methods for searching may be included, e.g. 1212. The user may perform the filter through selection of an apply selector button 1214. In the example, the filter may eliminate all patients except those over the age of 50 who are currently taking diabetes medication.

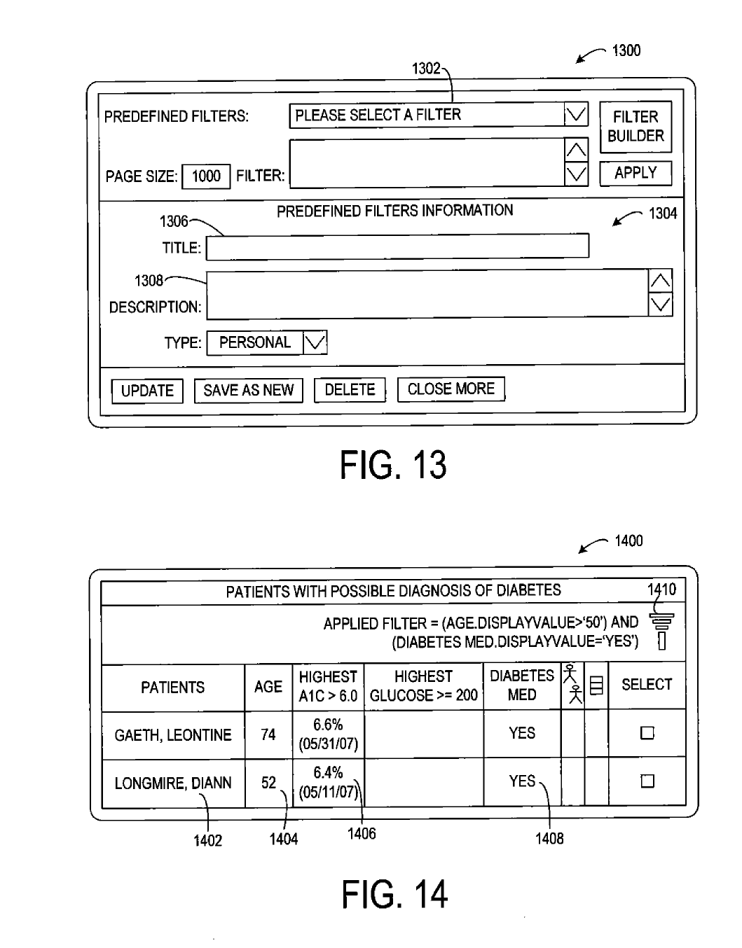

FIG. 13 illustrates an example interface 1300 for accessing a predefined filter for a patient management/communication system. A predefined filter includes search queries which have been previously set by a user. For example, the filter described in regards to FIG. 12 may be saved as a global filter, for example the filter may be saved as “Patients with Possible Diagnosis of Diabetes.” This description may be saved to enable other users to easily identify, regardless of technical knowledge, and utilize previous searches. A user may select the predefined filter which has been saved to the system, as indicated at 1302. As such, a user may be able to select the filter “Patients with Possible Diagnosis of Diabetes” and access the query described in FIG. 12. As described above, some users may have limited access to building such a global filter.

Predefined filter information 1304 may be provided and may enable a user to more easily access a predefined filter. Users may search for such predefined filters using a pull-down menu, by typing in the title, 1306, a description 1308, etc. Further, some embodiments may enable a user to search for individual or personal filters. For example, a user that saved a personal filter may be able to update, save, delete, and access their personal filter.

As described above, a user may build a filter and save the filter. The user may also access predefined filters, such as the filter described in FIG. 12. FIG. 14 illustrates an example interface applying the filter which was defined in FIG. 12 (specifically a filter which eliminates all patients except those over the age of 50 who are currently taking diabetes medication). A filter icon may be displayed to indicate that the data has been filtered, at 1410. The filter icon may be colored or may include indicators that provide notice that a filter has been applied to the data. In some embodiments, once the data has been filtered, the same data may not be able to be filtered against. However, in other embodiments, it may be possible to apply a second filter to previously filtered data. Thus, if patients are selected for review, the filter icon may remain with the data to indicate to a user that the patient was selected based on a filter. The filter icon further may provide information about how many patient records have been filtered and/or selected.

As illustrated at 1400, the filter may be titled “Patients with Possible Diagnosis of Diabetes” and eliminate all patients except those over the age of 50 who are currently taking diabetes medication. Thus, as illustrated, the a list of patients, such as Diann Longmire 1402 and various care parameters may be represented, including age, at 1404, test results, at 1406, medication types and levels, at 1408, etc.

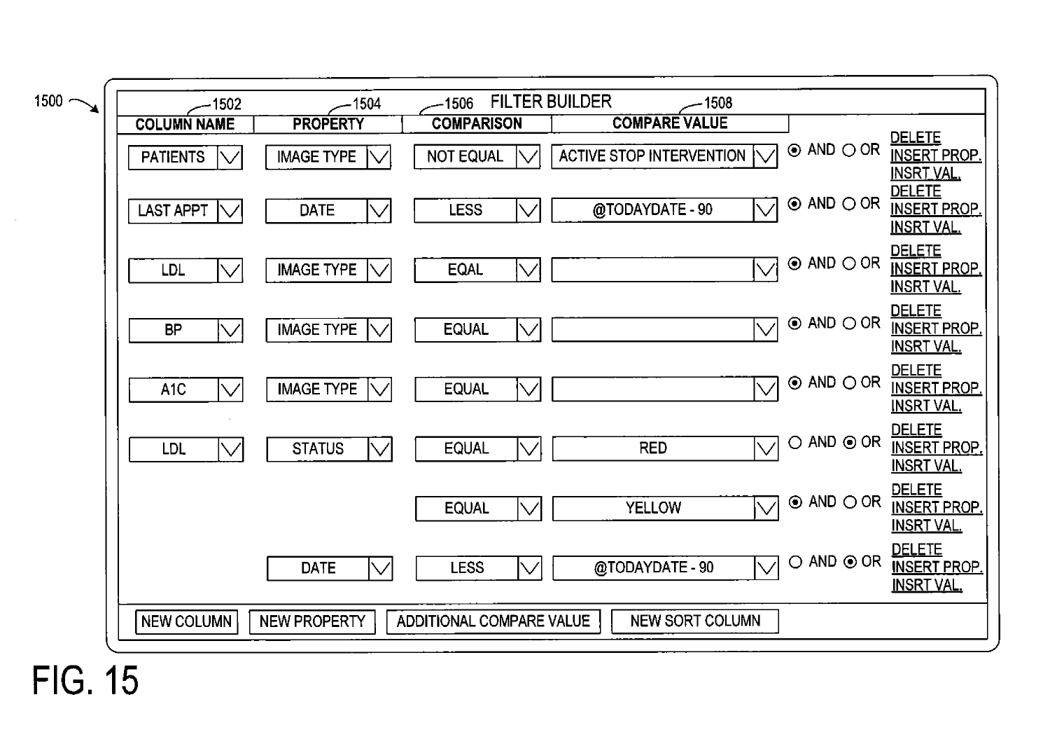

FIG. 15 illustrates another example filter builder 1500 in accordance with an embodiment of the present disclosure. The filter builder of FIG. 15 may enable development of an advanced query. As described above, the filter builder, may include selection of column name at 1502, property at 1504, comparison at 1506, and compare values at 1508. As described above, depending on the permission level, a user may save the filter as a personal filter or a global filter. Saving the filter enables access to the filter at a later time.

Once sorted, a user may select to send patient-specific communications to the sorted group. A user does not need to load a separate program or cut and paste data from one program to another. In contrast, the system enables an automatic selection process between the communication system and the management system, such that a user may select to automatically send a communication to a sorted group of patients. This easy-to-use interface prevents mistakes, increases the efficiency, and improves the exchange of communications with the patients.

The above-described systems, methods and interfaces enable improved communication between patients and providers. Such communications may be prepared as described above. The system minimizes additional load on providers while improving communication to patients. At-a-glance features, such as color-coding and intervention icons, enable users to quickly and easily identify issues and improve care to patients. Further, the use of such as-a-glance features in patient communications, enables patients to rapidly digest health related information from a provider.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

We claim:

1. A patient management system, comprising:
a care provider interface, configured to receive a selection of a plurality of patients; and
a data processing system configured to signal whether to exclude an individual patient within a subset of the plurality of patients based on an intervention parameter and further configured to send a communication to each of the patients in the subset.

2. The patient management system of claim 1 where the intervention parameter is determined by a provider.

3. The patient management system of claim 1 where the intervention parameter applies to information regarding at least one type of patient health parameter.

4. The patient management system of claim 1, where the intervention parameter applies to all communications to an individual patient.

5. The patient management system of claim 1 where the intervention parameter expires after a selected period.

6. The patient management system of claim 1 where the intervention parameter is displayed in the care provider interface for each patient in the form of an intervention icon.

7. The patient management system of claim 6, where the intervention icon is one of a stop indicator or a wait indicator.

8. The patient management system of claim 7, wherein the wait indicator automatically expires based on occurrence of a predetermined event.

9. The patient management system of claim 7, wherein the wait indicator includes a visual indication to identify expiration of the intervention.

10. An article of manufacture having code stored on a computer readable storage medium, comprising:
code for displaying a plurality of patients having or at risk for a common health condition;
code for receiving a selection of patients from the displayed patients;
code for automatically generating a plurality of personalized patient-specific communications based on the selection, the communications directed to selected individual patient, each patient communication based on and including at least a personalized patient health parameter specific to the individual patient;
code for identifying whether to include each patient in a subset for the communication based on an intervention parameter correlated to each patient; and
code for sending automatically generated communications the subset.

11. The article of manufacture of claim 10 where the intervention parameter is patient-specific.

12. The article of manufacture of claim 10 where the intervention parameter is topic-specific.

13. The article of manufacture of claim 10 where at least some of the intervention parameters automatically expire after a selected period.

14. The article of manufacture of claim 13, where the selected period is a variable time period based on provider selection.

15. The article of manufacture of claim 10, where the where at least some of the intervention parameters remain correlated with a patient until a provider removes the intervention parameter.

16. The article of manufacture of claim 10 further comprising: code for automatically updating respective patient electronic medical record (EMR) database records with the personalized patient-specific communications to generate an audit trail for each communication sent.

17. A method of operating a patient management system, comprising:
displaying a plurality of patients having or at risk for a common health condition, said patients identified based on patient information extracted from an electronic medical record (EMR) database;
receiving a selection of patients from the displayed patients;
generating a plurality of personalized patient-specific communications based on the selection, the communications directed to a set of selected individual patient, each patient communication based on and including at least a personalized patient health parameter specific to the individual patient, the plurality of personalized patient-specific communications directed to selected patients, the set of selected individual patients excluding patients previously identified to be excluded for the communication based on prior provider intervention; and
sending the communication to the set of selected individual patients.

18. The method of claim 17, wherein the exclusion of the patient is based on an intervention parameter for the patient.

19. The method of claim 18, wherein the intervention parameter is topic-specific.

20. The method of claim 18, wherein the intervention parameter expires after a selected time period.
